(19) United States
(12) Patent Application Publication
(10) Pub. No.: US 2015/0171391 A1
(43) Pub. Date: Jun. 18, 2015

(54) Battery Module

(71) Applicant: Samsung SDI Co., Ltd., Yongin-si (KR)

(72) Inventor: Jang-Gun Ahn, Yongin-si (KR)

(21) Appl. No.: 14/558,689

(22) Filed: Dec. 2, 2014

(30) Foreign Application Priority Data
Dec. 16, 2013 (KR) 10-2013-0156218

(51) Int. Cl. H01M 2/12

(52) U.S. Cl. CPC H01M 2/12

(57) ABSTRACT

A battery module including a plurality of battery cells arranged in a direction; a pair of end barriers respectively arranged at opposite ends of the plurality of battery cells; an end plate coupled to an outer surface of an end barrier of the pair of end barriers and having a shape corresponding to the end barrier; and a guide member between the end barrier and the end plate to guide a flow of gas generated in the plurality of battery cells.

### CROSS-REFERENCE TO RELATED APPLICATION

This application claims priority to and the benefit of Korean Patent Application No 10-2013-0156216, filed on Dec. 16, 2013 in the Korean Intellectual Property Office, the entire content at which is incorporated herein by reference.

### BACKGROUND

1. Field

Aspects of embodiment of the present invention relate to a battery module.

2. Description of the Related Art

As industries of electronics, communications and the like are rapidly developed, the spread of portable electronic devices such, as a camcorder, a cellular phone and a notebook PC has recently been increased. Accordingly, the use of secondary batteries has also been increased. The secondary batteries can be used for not only portable electronic devices but also medium- and large-sized apparatuses, such as an electric tool, an automobile, a space transportation means, a motorbike, a motor scooter and an aerial transportation means, which require high output and high power. The secondary batteries used for the medium- and large-sized apparatuses constitute a large-capacity battery module or battery pack by connecting a plurality of battery cells in series or parallel.

The battery module can be configured with a plurality of battery cells. The battery cell is degraded as the amount of charging/discharging of the battery cell increases, and gas is generated inside the battery cell due to a side reaction between an electrode assembly and an electrolyte. Accordingly, various studies on a method of exhausting the generated gas to an outside of the battery module have been conducted.

### SUMMARY

According to an aspect of embodiments of the present invention, a battery module includes an exhaust hole formed to exhaust gas and dust generated from a battery cell to an outside thereof.

According to another aspect of embodiments of the present invention, a battery module has a structure in which gas and dust generated from a battery cell is exhausted through a protruding hole from an exhaust hole.

According to another aspect of embodiments of the present invention, a battery module includes an elastic member formed such that an end plate and an end barrier can be closely fastened to each other.

According to another aspect of embodiments of the present invention, a battery module includes an exhaust hole and a protruding hole, which are formed at positions crossing each other in a vertical direction.

According to another aspect of embodiments of the present invention, a battery module includes an end barrier formed of an insulator so that current does not flow therein.

According to one or more embodiments of the present invention, a battery module includes: a plurality of battery cells arranged in a direction; a pair of end barriers respectively arranged at opposite ends of the plurality of battery cells; an end plate coupled to an outer surface of an end barrier of the pair of end barriers and having a shape corresponding to the end barrier; and a guide member between the end barrier and the end plate to guide a flow of gas generated in the plurality of battery cells.

The end barrier may have an exhaust hole for exhausting the gas therethrough.

The guide member may include a passage portion defining a passage through which the gas exhausted through the exhaust hole is flowed, and a protruding opening portion through which the flowed gas is exhausted at an end portion of the passage.

The protruding opening portion and the exhaust hole relay be formed to cross each other in a vertical direction.

A coupling hole may be formed at a position corresponding to the protruding opening portion at a side of the end plate, and the protruding opening portion may be inserted into the coupling hole.

The battery module may further include an elastic member between the end barrier and the end plate.

The elastic member may not overlap with the guide member.

A thickness of the elastic member may be equal to a thickness of the guide member.

The elastic member may include a rubber material.

The end barrier may be formed of an insulator.

The end plate may include a frame portion at an outer surface of the end plate, and a stepped portion recessed to a depth inward from the frame portion.

The stepped portion may include a protruding portion extended in a lengthwise direction of the frame portion.

The battery module may further include: side plates respectively configured to support side surfaces of the plurality of battery cells; a bottom plate coupled to lower ends of the side plates to support bottom surfaces of the battery cells; and a top plate coupled to upper ends of the side plates to be positioned on top surfaces of the battery cells.

As described above, in a battery module according to one or more embodiments of the present invention, gas and dust generated from the battery cell can be exhausted to the outside of the battery module through the exhaust hole, such that a separate degassing device is unnecessary. Accordingly, the battery module can be simply assembled. Further, manufacturing cost may be reduced while realizing miniaturization of the battery module.

Further the guide member is provided such that the gas generated from the battery cell can be exhausted to the outside of the battery module through the exhaust hole formed in the end barrier. Accordingly, it is possible to quickly and easily exhaust the gas, thereby preventing or substantially preventing in advance an accident caused by swelling of the battery cell.

Further, the elastic member is provided between the end plate and the end barrier, such that the end plate and the end barrier can be closely fastened to each other. Accordingly, the battery cells are not easily moved by an external impact, thereby improving the safety of the battery module.

### BRIEF DESCRIPTION OF THE DRAWINGS

Some example embodiments of the present invention are described more fully hereinafter with reference to the accompanying drawings; however, the present invention may be embodied in different forms and should not be construed as limited to the embodiments set forth herein. Rather, the accompanying drawings, together with the specification, illustrate some example embodiments of the present invention, and serve to explain principles and aspects of the present invention.

In the drawing figures, dimensions may be exaggerated for clarity of illustration. Like reference numerals refer to like elements throughout.

FIG. 1 is a perspective view of a battery module according to an embodiment of the present invention.

FIG. 2 is a partial exploded perspective view of the battery module of FIG. 1.

FIG. 3 is a partial sectional view of the battery module of FIG. 1.

FIG. 4 is a perspective view of a battery module according to another embodiment of the present invention.

FIG. 5 is a partial exploded perspective view of the battery module of FIG. 4.

### DETAILED DESCRIPTION

In the following detailed description, certain exemplary embodiments of the present invention are shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. It will be understood that when an element is referred to as being “between” two elements, it can be the only element between the two elements, or one or more intervening elements may also be present. In addition, when an element is referred to as being “on” another element, it can be directly on the another element or indirectly on the another element with one or more intervening elements interposed therebetween. Similarly, when an element is referred to as being “connected to” another element, it can be directly connected to the another element or indirectly connected to the another element with one or more intervening elements interposed therebetween. Hereinafter, like reference numerals refer to like elements.

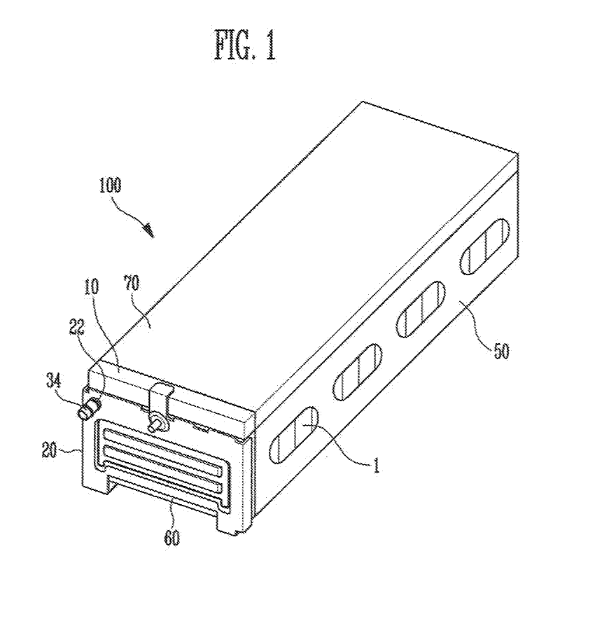

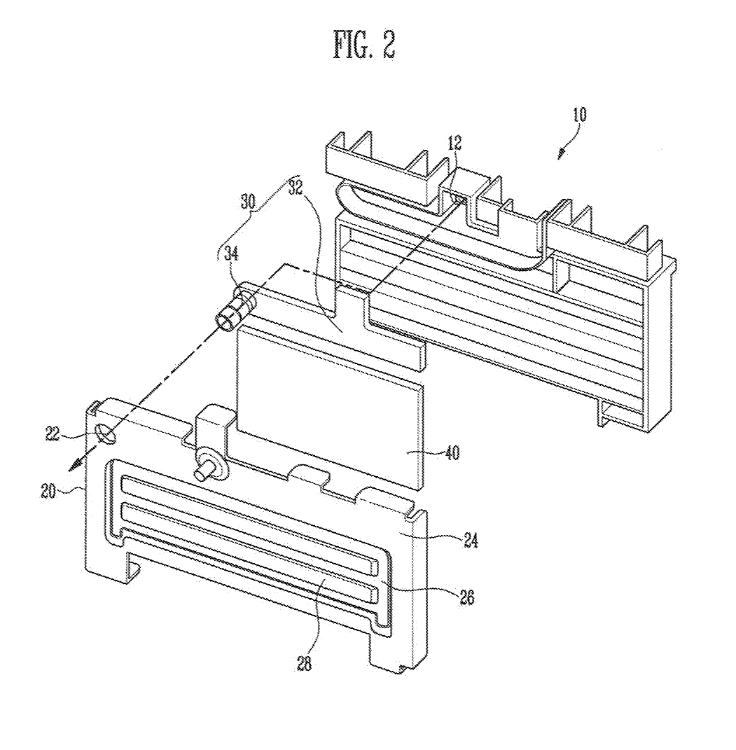

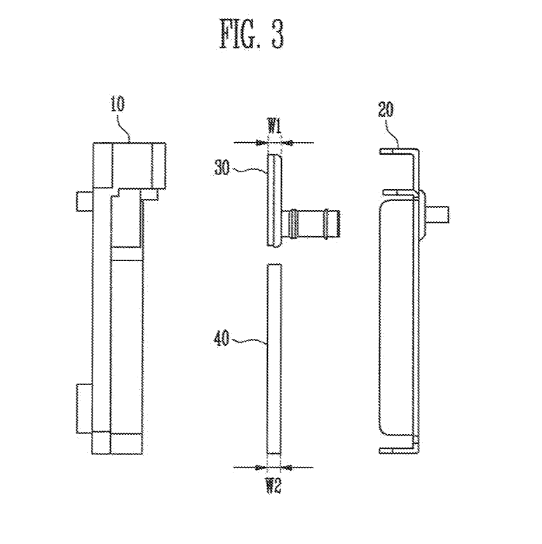

FIG. 1 is a perspective view of a battery module 100 according to an embodiment of the present invention. FIG. 2 is a partial exploded perspective view of the battery module 100. FIG. 3 is a partial sectional view of the battery module 100.

As shown in FIGS. 1 to 3, the battery module 100 according to an embodiment of the present invention includes a plurality of battery cells 1 aligned in a direction, a pair of end barriers 10 respectively coupled to both ends of the plurality of battery cells 1, and a pair of end plates 20 each coupled to an outer surface of a respective one of the end barriers 10 and having a shape corresponding to the end barrier 10.

The battery cell 1, in one embodiment, is a lithium on (Li-ion) battery cell. The battery cell 1, in one embodiment, has a prismatic shape (e.g., a quadrangular shape). The battery cells 1, in one embodiment, are aligned in one direction such that wide front surfaces of the battery cells 1 are opposite to each other. Although it is illustrated in FIG. 1 that the battery cell 1 has a prismatic shape, the present invention is not limited thereto. That is, the battery cell 1 may be formed in various shapes, such as a cylindrical shape or an elliptical shape. In addition, the number and arrangement of the battery cells are not limited to the embodiment shown in FIG. 1.

The end barrier 10, in one embodiment, is formed of an insulator for the purpose of insulation between the battery cell 1 and the end plate 20 described later. The end barriers 10 are respectively provided on outer surfaces of outermost battery cells 1 of the plurality of battery cells 1. The end barrier 10 includes an exhaust hole 12 configured to exhaust gas generated by the battery cell 1 (e.g., by degradation of the battery cell 1 and/or a side reaction between an electrode assembly and an electrolyte of the battery cell 1).

The exhaust hole 12, in one embodiment, is formed as a cylinder-shaped through hole in the end barrier 10, and may be formed at one side of the end barrier 10, to perform a function of exhausting gas generated from the battery cell 1. The shape and size of the exhaust hole 12 are not limited to the embodiment shown in FIG. 2. That is in another embodiment of the present invention, the exhaust hole 12 may have another shape and/or size.

The end plate 20 is coupled to an outer surface of the end barrier 10 by being formed in a shape and size corresponding to the end barrier 10. A coupling hole 22 is formed at a side of the end plate 20. In one embodiment, the coupling hole 22 is formed at, a position crossing that of the exhaust hole 12 in a vertical direction.

In one embodiment, a stepped portion 26 is formed to be recessed by a depth (e.g., a predetermined depth) inward from a frame portion 24 at an outer surface of the end plate 20. A protruding portion 28 may be formed to extend in a lengthwise direction of the frame portion 24 at the stepped portion 26. The protruding portion 28 may be positioned on a same line as the frame portion 24 in a horizontal direction. In one embodiment, the stepped portion 26 and the protruding portion 28 are formed in the end plate 20, such that a thickness of the end plate 20 may be reduced, thereby decreasing the weight of the battery module 100.

The battery module 100, in one embodiment, further includes a guide member 30 between the end barrier 10 and the end plate 28 for guiding the flow of gas.

The guide member 30, in one embodiment, includes a passage portion 32 through which the gas exhausted through the exhaust hole 12 is flowed, and a protruding opening portion 34 through which the flowed gas is exhausted. The protruding opening portion 34 may be at one end portion of the passage portion 32.

The passage portion 32, in one embodiment, is formed in a projection shape in the guide member 30 to be closely coupled to the outer surface of the end barrier 10, thereby defining a gas flow path together with the end barrier 10. Accordingly, the gas exhausted through the exhaust hole 12 flows along the gas flow path defined by the passage portion 32 and then reaches the protruding opening portion 34, as described further below.

The protruding opening portion 34 may be formed at one side of the passage portion 32, and may be at a position crossing that of the exhaust hole 12 in the vertical direction. The protruding opening portion 34 is formed at a position corresponding to the same line as the coupling hole 22 in the vertical direction. In one embodiment, the diameter of the protruding opening portion 34 s formed smaller than that of the coupling hole 22 such that the protruding opening portion 34 can be connected to the coupling hole 22 by being inserted into the coupling hole 22. Although it is illustrated in FIGS. 1 and 2 that the protruding opening portion 34 and the coupling hole 22 have a circular shape, the present invention is not limited thereto. That is, in another embodiment, the protruding opening portion 34 and the coupling hole 22 may have another shape and/or size such that the protruding opening portion 34 is connected to the coupling hole 22 by being inserted into the coupling hole 22.

As shown in FIG. 3, in one embodiment, the battery module 100 further includes an elastic member 40 between the end plate 20 and the end barrier 10.

The elastic member 40, in one embodiment, is made of a rubber material. The elastic member 40 may be formed on an inner surface of the end plate 20 so as not to overlap with the guide member 30. A thickness W2 of the elastic member 40, in one embodiment, is equal to a thickness W1 of the guide member 30 such that the end barrier 10 and the end plate 20 can be closely fastened to each other. As described above, the elastic member 40 may be further provided such that the end barrier 10 and the end plate 20 may be firmly sealed. Accordingly, when a degassing situation occurs, the battery module 100 has a sufficient sealing performance, thereby improving the safety of the battery module 100.

As shown in FIG. 1, the battery module 100 according to an embodiment of the present invention may further include side plates 50 configured to support both side surfaces of the battery cells 1, a bottom plate 60 coupled to lower ends of the side plates 50 to support bottom surfaces of the battery cells 1, and a top plate 70 coupled to upper ends of the side plates 50 and positioned on top surfaces of the battery cells 1.

As described above, in one embodiment, the side plate 50, the bottom plate 60, and the top plate 70 are further provided, such that the battery cells 1 may be more closely fixed in a space defined by these plates. Accordingly, the battery cells 1 are not easily moved by an external impact, thereby improving the safety of the battery module 100.

In one embodiment, a buffer surface made of an elastic material may be further formed at an inner surface of one or more of the side plate 50, the bottom plate 60, and the top plate 70 so as to stably accommodate the battery cells 1.

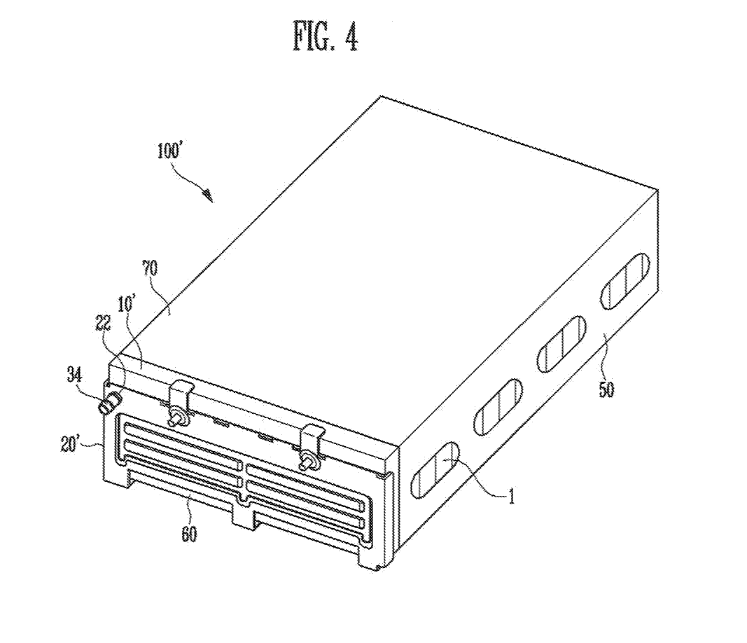

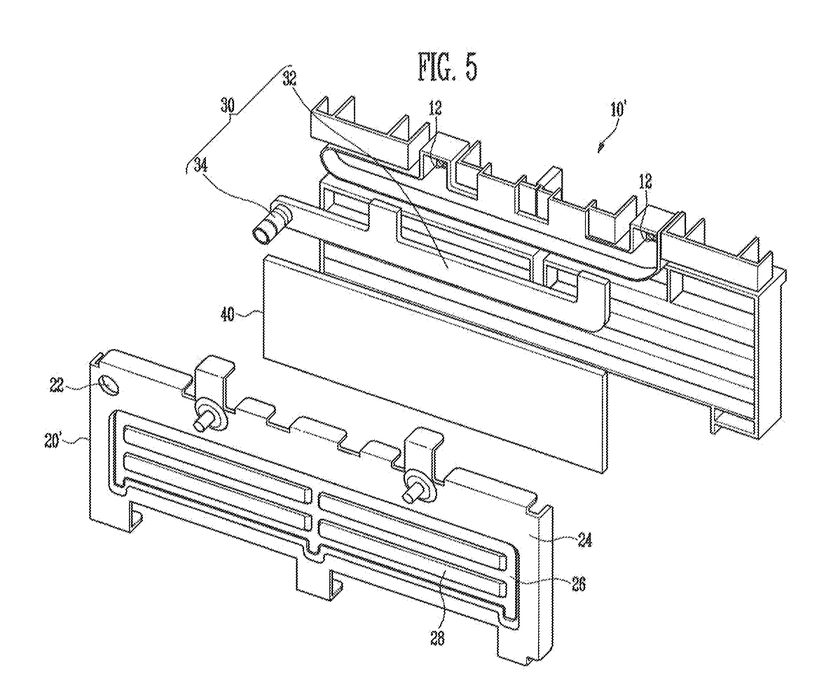

FIG. 4 is a perspective view of a battery module 100′ according to another embodiment of the present invention. FIG. 5 is a partial exploded perspective view of the battery module 100′.

As shown in FIGS. 4 and 5, an end barrier 10′ and an end plate 20′ of the battery module 100′ may be larger than the end barrier 10 and the end plate 20 of the battery module 100 described above. As the end barrier 10′ and the end plate 20′ are larger, the end barrier 10′ and the end plate 20′ can be coupled to outer surfaces of not only a first plurality of battery cells 1 connected in series but also a second plurality of battery cells 1 aligned in parallel with the first plurality of battery cells 1.

According to embodiments of the present invention, gas and dust generated from the battery cells can be exhausted to the outside of the battery module through the exhaust hole such that a separate degassing device is unnecessary. Accordingly, the battery module can be simply assembled. Further, it is possible to reduce manufacturing cost and to realize miniaturization of the battery module.

In addition, the guide member is provided such that the gas generated from the battery cells can be exhausted to the outside of the battery module through the exhaust hole formed in the end barrier. Accordingly, it is possible to quickly and easily exhaust the gas, thereby preventing or substantially preventing in advance an accident caused by swelling of the battery cell.

While some exemplary embodiments of the present invention have been disclosed herein, and although specific terms are employed, they are used and are to be interpreted in a generic and descriptive sense only at and not for purposes of limitation. In some instances, as would be apparent to one of ordinary skill in the art, features, characteristics, and/or elements described in connection with a particular embodiment may be used in combination with features, characteristics, and/or elements described in connection with other embodiments, unless otherwise specifically indicated. Accordingly, it will be understood by those of skill in the art that various changes in form and details may be made without departing from the spirit and scope of the present invention as set forth in the following claims and equivalents thereof.

What is claimed is:

1. A battery module comprising:
a plurality of battery cells arranged in a direction;
a pair of end barriers respectively arranged at opposite ends of the plurality of battery cells;
an end plate coupled to an outer surface of an end barrier of the pair of end barriers and having a shape corresponding to the end barrier; and
a guide member between the end barrier and the end plate to guide a flow of gas generated in the plurality of battery cells.

2. The battery module of claim 1, wherein the end barrier has an exhaust hole for exhausting the gas therethrough.

3. The battery module of claim 1, wherein the guide member includes a passage portion defining a passage through which the gas exhausted through the exhaust hole is flowed, and a protruding opening portion through which the flowed gas is exhausted at an end portion of the passage.

4. The battery module of claim 3, wherein the protruding opening portion and the exhaust hole are formed to cross each other in a vertical direction.

5. The battery module of claim 3, wherein a coupling hole is formed at a position corresponding to the protruding opening portion at a side of the end plate, and the protruding opening portion is inserted into the coupling hole.

6. The battery module of claim 1, further comprising an elastic member between the end barrier and the end plate.

7. The battery module of claim 6, wherein the elastic member does not overlap with the guide member.

8. The battery module of claim 6, wherein thickness of the elastic member is equal to a thickness of the guide member.

9. The battery module of claim 6, wherein the elastic member comprises a rubber material.

10. The battery module of claim 1, wherein the end barrier is formed of an insulator.

11. The battery module of claim 1, wherein the end plate comprises a frame portion at an outer surface of the end plate, and a stepped portion recessed to a depth inward from the frame portion.

12. The battery module of claim 11, wherein the stepped portion includes a protruding portion extended in a lengthwise direction of the frame portion.

13. The battery module of claim 1, further comprising:
side plates respectively configured to support side surfaces of the plurality of battery cells;
a bottom plate coupled to lower ends of the side plates to support bottom surfaces of the battery cells; and
a top plate coupled to upper ends of the side plates to be positioned on top surfaces of the battery cell.
